(19) United States
(12) Patent Application Publication
(10) Pub. No.: US 2025/0337521 A1
(43) Pub. Date: Oct. 30, 2025

(54) DETERMINING INDICATIONS OF SIGNAL QUALITY BASED ON DIGITAL EYE WIDTH

(71) Applicant: Microchip Technology Incorporated, Chandler, AZ (US)

(72) Inventors: Jiachi Yu, Foshan (CN); Venkatraman Iyer, Austin, TX (US); Kevin Yang, Shenzhen (CN); Thor Lei Xia, Shenzhen (CN); Hongming An, San Diego, CA (US)

(21) Appl. No.: 19/223,944

(22) Filed: May 30, 2025

Related U.S. Application Data
(63) Continuation-in-part of application No. PCT/CN2024/089715, filed on Apr. 25, 2024.

(51) Int. Cl. H04L 1/00

(52) U.S. Cl. CPC H04L 1/0026; H04L 1/0028

(57) ABSTRACT

A method includes generating a digital eye mask representative of a digital eye diagram of bits of a received signal, the bits encoded utilizing zero-crossings; and generating an indication of quality for the received signal, the indication of quality proportional to a determined eye width of the digital eye diagram, the determined eye width obtained from the generated digital eye mask.

### CROSS-REFERENCE TO RELATED APPLICATIONS

This application is a continuation-in-part of, and claims priority under 35 U.S.C. § 120 and 35 U.S.C. § 365(c) to, International Patent Application No. PCT/CN2024/089715, filed Apr. 25, 2024, the disclosure of which is incorporated herein by this reference in its entirety.

### FIELD

One or more examples relate, generally, to determining digital eye width and indications of signal quality based thereon.

### BACKGROUND

Eye diagrams are utilized in digital electronic communications to analyze the quality of digital signals.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of an apparatus to generate an indication of signal quality for a received signal, in accordance with one or more examples.

FIG. 2 is a block diagram depicting an apparatus to generate an indication of signal quality (SQI) at least partially based on a digital eye mask, in accordance with one or more examples.

FIG. 3 is a block diagram depicting an apparatus to generate an edge signal, in accordance with one or more examples.

FIG. 4 is a block diagram depicting an apparatus to generate an edge detection signal, in accordance with one or more examples.

FIG. 5 is a diagram depicting an example eye width determination in accordance with one or more examples.

FIG. 6 is a diagram depicting an array representation of a digital eye mask depicted by FIG. 5, in accordance with one or more examples.

FIG. 7 is a block diagram of an apparatus to determine an eye width based on a digital eye mask, in accordance with one or more examples.

FIG. 8 is a flow diagram that illustrates an example process to generate an indication of signal quality for a received signal in accordance with one or more examples.

FIG. 9 is a flow diagram that illustrates an example process to generate a digital eye mask in accordance with one or more examples.

FIG. 10 is a flow diagram that illustrates an example process to generate an edge signal according to one or more examples.

FIG. 11 is a flow diagram that illustrates an example process to determine values of a digital eye mask in accordance with one or more examples.

FIG. 12 is a flow diagram that illustrates an example process to determine an eye with based on a digital eye mask in accordance with one or more examples.

FIG. 13 is a flow diagram that illustrates an example process to determine leading and trailing edges of an eye diagram based on a digital eye mask in accordance with one or more examples.

FIG. 14 illustrates an example process to determine an indication of quality, in accordance with one or more examples.

FIG. 15 illustrates an example process to determine an indication of quality, in accordance with one or more examples.

FIG. 16 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application-Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a connection, means, respectively, to assert or de-assert a signal associated with the connection (e.g., a signal specifically assigned to the connection or a signal to which the connection is specifically assigned, without limitation).

An eye diagram provides a means to assess the overall quality and consistency of a digital signal and, optionally, performance of a digital transmission system or portion thereof. An eye diagram is formed by superimposing one or more segments of the waveform of a digital signal on top of each other. The segments are aligned such that the bit transitions occur at the same points in time on the horizontal axis. This overlapping creates a composite picture. An eye diagram may provide a visual indication of signal quality and optionally performance of a digital transmission system. Aspects include the width of the eye opening (horizontal dimension or span), which indicates the time period over which the signal can be reliably sampled, and the height of the eye opening (vertical dimension or span), which shows the margin between logic levels.

A wide-open eye, i.e., where the height of the eye opening is comparatively large, is indicative of a clear distinction between ones and zeros in a digital signal, implying good signal quality. Conversely, a closed or distorted eye, i.e., where the height of the eye opening is comparatively small, indicates poor signal quality, which may be due to noise, distortion, jitter, or other signal impairments. The “eye width” is the horizontal span at the center of the eye diagram, and it represents the time interval where the signal is most stable and less subject to jitter. Since jitter is inversely related to signal quality (e.g., higher jitter/lower signal quality, lower jitter/higher signal quality, without limitation), Measuring eye width provides an indication of the signal's quality. An eye opening having a wider span is indicative of a higher signal quality that is less suspectable to jitter than an eye opening having a narrower span, which is indicative of a lower signal quality that is more susceptible to jitter.

It is appreciated that it may be advantageous to determine eye width digitally and use the digitally determined eye width to determine an indication of signal quality. The terms “indication of signal quality” and “signal quality indication” are used interchangeably herein to mean “indication of signal quality.”

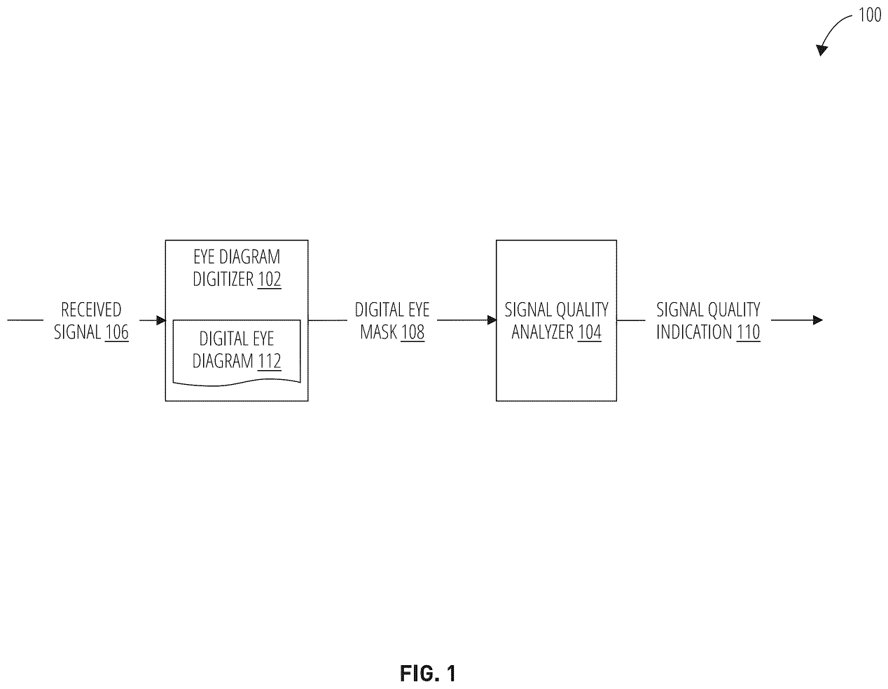

FIG. 1 is a block diagram of an apparatus 100 to generate an indication of signal quality for a received signal, in accordance with one or more examples.

Apparatus 100 includes eye diagram digitizer 102 and signal quality analyzer 104.

Eye diagram digitizer 102 generates a digital eye mask 108 at least partially based on a received signal 106. Received signal 106 is a digital signal received via, as a non-limiting example, a digital transmission system coupled to, or including, apparatus 100. In one or more examples, the digital transmission system may be based on 10BASE-TIS, which is a network technology specified in IEEE 802.3cg™. IEEE 802.3cg specifies physical layer (PHY) behavior for Physical Layer Collision Avoidance (PLCA). The Open Alliance (OA) Tech Committee (TC) 14 adds other specifications for automotive use of a PHY. For example, the OA's TC 14 specifies advanced diagnostics including signal quality indication. Other networking topologies do not exceed the scope of this disclosure. In one or more examples, received signal 106 may be a bit stream (e.g., a sequence of bits, some or a totality of which are continuous, without limitation) with bits that are encoded using zero crossings such as phase encoding, Manchester encoding, or differential Manchester encoding (DME), or encoded using return-to-zero or non-return-to-zero encoding schemes.

Digital eye mask 108 is a representation of a digital eye diagram 112. Digital eye diagram 112 includes superposed segments of waveforms, represented digitally as described herein, of a digital signal, here received signal 106. A length of a segment may correspond to one or more unit intervals of received signal 106. In one or more examples discussed herein, a unit interval is based on a bit interval. The specific length of a unit interval may be at least partially based on specific operating conditions. As a non-limiting example, the length of a unit interval may be greater than the length of a standard bit interval to reliably encompass potential distortion of the waveforms (e.g., lengthening, without limitation) of transmitted digital signals. In one or more examples, a unit interval may be denoted in a unit of time. In examples herein where the unit interval is based on a bit interval, the segment of a waveform of a digital signal is referred to as a “bit” (e.g., a “bit of received signal 106”).

In one or more examples, eye diagram digitizer 102 may generate digital eye diagram 112 at least partially based on received signal 106. In one or more examples, eye diagram digitizer 102 may include, or have access to, an eye pattern generator, a digital storage oscilloscope (hardware or software), eye diagram analysis software, or other signal analyzers (digital signal processor (DSP) hardware or software) that, respectively generates eye diagrams of digital signals. One or more superposed waveforms of digital eye diagram 112 correspond to respective one or more bits of received signal 106. In some instances, one or more waveforms of digital eye diagram 112 may correspond to a same, single bit of the received signal 106 (e.g., a repeatedly transmitted bit, without limitation) and in other instances, one or more waveforms of digital eye diagram 112 may correspond to waveforms of respective, different bits of received signal 106.

Digital eye mask 108 is a simplified representation of digital eye diagram 112 generated by eye diagram digitizer 102, for example, as discussed below. In one or more examples, a digital eye mask is 1×N array (‘N’ is an integer greater than 0) where cells of the array represent sub-intervals of the unit interval of an eye diagram. In one or more examples, cells of the array sequentially represent consecutive, equal-duration, sub-intervals of a unit interval of the eye diagram. The values of the cells indicate a portion of an eye closure or a portion of an eye opening of the eye diagram, as the case may be. As a non-limiting example, a value of 0 may indicate an eye opening in a respective sub-interval, and a value of 1 may indicate an eye closure in a respective sub-interval. Since the cells of the array sequentially represent consecutive, equal-duration, sub-intervals of a unit interval of the eye diagram, an eye width of digital eye diagram 112 may be determined at least partially based on the number of eye openings between eye closures, for example, by counting the number of occurrences of consecutive eye openings between occurrences of eye closures.

Signal quality analyzer 104 generates a signal quality indication 110 at least partially based on digital eye mask 108.

In one or more examples, signal quality analyzer 104 determines one or more eye widths based on digital eye mask 108 as discussed, below, and generates signal quality indication 110 at least partially based thereon. In one or more examples, signal quality indication 110 may be directly proportional to an eye width indicated by digital eye mask 108. Here, the term “proportional” when used to describe the relationship between an indication of signal quality and eye width means that there is a direct relationship between a value of the indication of signal quality and a value of the eye width. As eye width values change (e.g., increase or decrease, without limitation), the values of the indication of quality may also change (e.g., increase or decrease, without limitation). The relationship is such that changes in the value of the eye width cause a reliably predictable and corresponding change in the value of the indication of signal quality. The amount of change in the value of the eye width to which the indication of signal quality will respond depends on specific operating conditions, as a non-limiting example, a desired sensitivity. By way of non-limiting example, the value of the indication of quality may change by step sizes in response to corresponding step size changes in the value of eye width. By way of a further non-limiting example, a value of the indication of quality may be set in response to a value of eye width being above or below one or more predetermined thresholds.

In some examples, the relationship between signal quality indication 110 and eye width obtained based on a digital eye mask 108 may be predetermined based on observation of the change in eye width values obtained from digital eye mask 108 discussed herein versus change in signal quality in similar or same digital communication systems. In some examples, signal quality indication 110 may be based on a predetermined threshold, and signal quality indication 110 may indicate whether signal quality is above or below the predetermined threshold. Such a predetermined threshold may be set at least partially based on observation of the change in eye width values (obtained from digital eye masks 108 discussed herein) versus change in signal quality in similar or same digital communication systems.

In one or more examples, the signal quality indication 110 may be compared to a predetermined threshold, and an interrupt may be generated in response to the signal quality being below the predetermined threshold. In one or more examples, the predetermined threshold may be set at least partially based on specific operating conditions or observation of similar or the same digital communication system and determination of thresholds below which the received signal 106 cannot be reliably read.

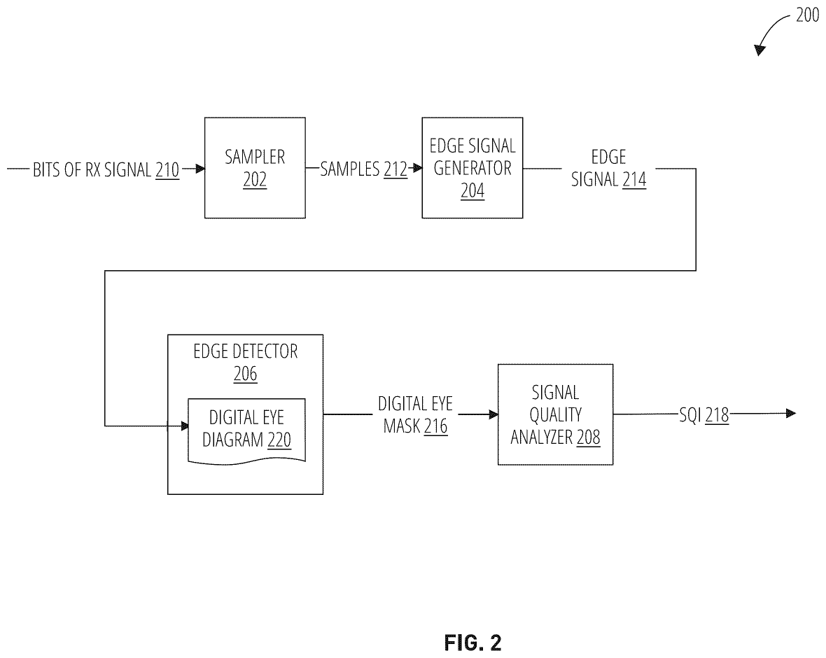

FIG. 2 is a block diagram depicting an apparatus 200 to generate an indication of signal quality at least partially based on bits of a received signal, in accordance with one or more examples.

Apparatus 200 includes sampler 202, edge signal generator 204, and edge detector 206. The sampler 202, edge signal generator 204, and edge detector 206 are a non-limiting example of an eye diagram digitizer 102 of FIG. 1, and signal quality analyzer 208 is a non-limiting example of a signal quality analyzer 104 of FIG. 1.

Sampler 202 is an M times sampler, where M is an oversampling factor and is an integer greater than 0. Sampler 202 generates samples 212 of respective bits of RX signal 210. In one or more examples, sampler 202 generates a sample value of ‘1’ to indicate a high value of a signal and generates a sample value of ‘0’ to indicate a low value of the signal. A set of M samples generated by sampler 202 represents a bit of the RX signal 210. In one or more examples, the oversampling factor M may be predetermined invariant integer chosen based on, as a non-limiting example, specific operating conditions (e.g., chosen according to one or more of clock-frequency availability, desired temporal resolution, hardware resource constraints, applicable protocol requirements, without limitation). Alternatively, in one or more examples, the over sampling factor M may be adaptively varied by dynamically increasing or decreasing the sampler rate as a function of, as a non-limiting example, specific operating conditions (e.g., one or more of signal bandwidth or recovered clock margin, without limitation).

Further, the present disclosure expressly contemplates extracting additional eye-diagram metrics—such as eye height, eye area, or other composite figures-of-merit-from the same sampled data, and the computation and use of such metrics remain fully within the scope of the inventive concepts set forth herein.

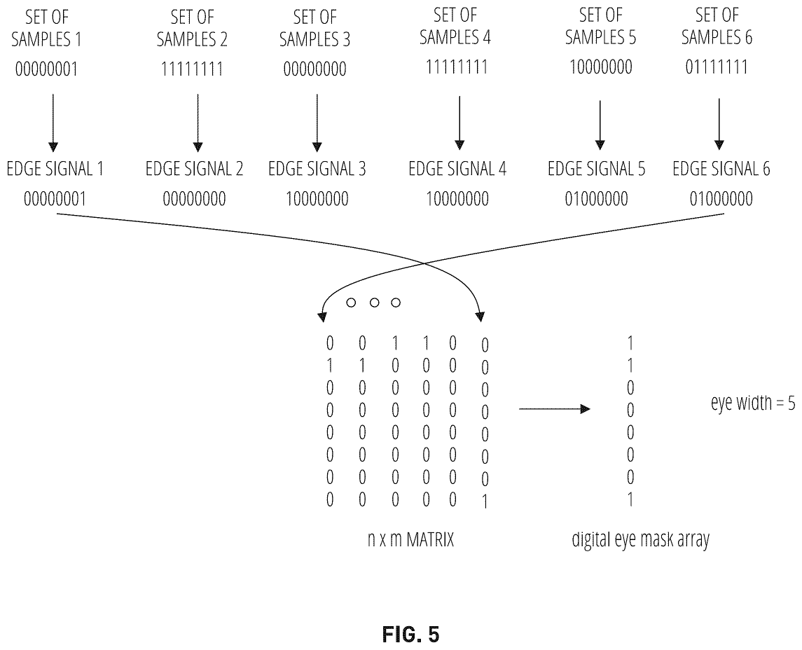

Edge signal generator 204 receives samples 212, analyzes respective samples 212, and generates an edge signal 214 to indicate edges, if any, it observes in respective samples 212. As illustrated by an example discussed with respect to FIG. 5, edge signal 214 also indicates timing in the bit interval when an edge occurred. An edge is a state change from a high state to a low state or a low state to a high state.

Edge detector 206 receives edge signal 214, generates an internal digital eye diagram 220 at least partially based on edge signal 214, determines whether or not edges are present in sub-intervals of the digital eye diagram sampler 202 (e.g., detects the presence of edges as discussed below), and generates digital eye mask 216 to indicate whether or not edges were detected in respective sub-intervals of the digital eye diagram 220. In one or more examples, edge detector 206 sets one or more values of digital eye mask 216 to indicate TRUE (edge detected) or FALSE (no edge detected), as discussed below.

Signal quality analyzer 208 determines signal quality at least partially based on digital eye mask 216 (e.g., via eye width values, without limitation) and generates indication of signal quality 218 (SQI 218) at least partially based on the determined signal quality.

In one or more examples, signal quality analyzer 208 may determine an indication of signal quality based on one or more eye width values. For example, signal quality analyzer 208 may determine an indication of quality based on a single eye width value. Additionally or alternatively, signal quality analyzer 208 may determine an indication of signal quality based on multiple eye width values. When using multiple eye width values, signal quality analyzer 208 may determine an indication of signal quality to be proportional to an eye width exhibiting a highest frequency of occurrence across the various digital eye diagrams for sets of bits. Additionally or alternatively, signal quality analyzer 208 may determine an indication of signal quality to be proportional to a lowest one of the eye widths (e.g., lowest eye width value, without limitation). Using the lowest (narrowest) width is a conservative approach. Additionally or alternatively, signal quality analyzer 208 may determine the indication of signal quality to be proportional to the average or median eye width (e.g., average, or median of the eye width values, without limitation) may be used.

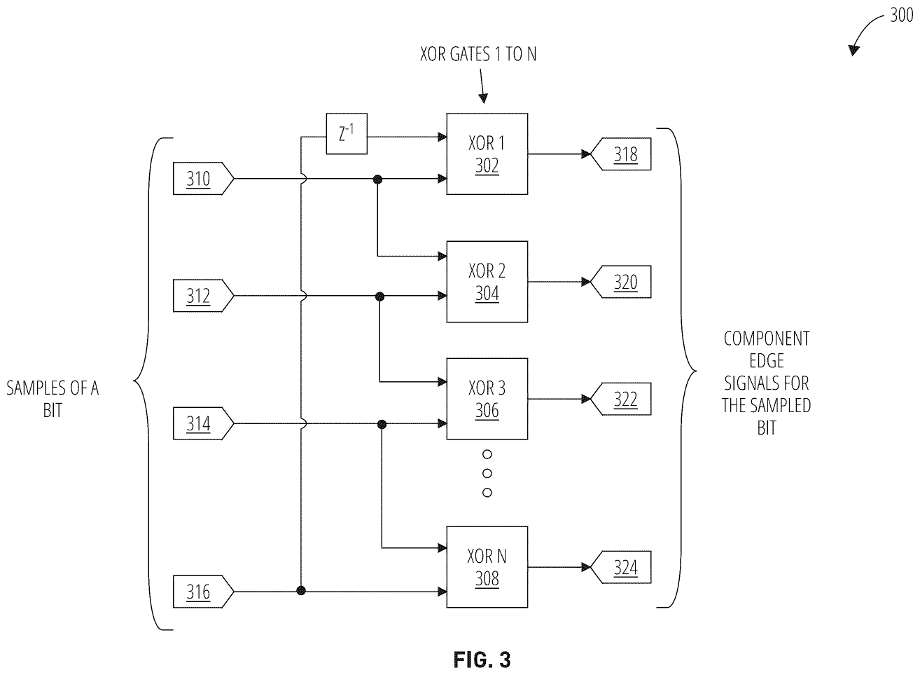

FIG. 3 is a block diagram depicting an apparatus 300 to generate an edge signal, in accordance with one or more examples. Apparatus 300 is a non-limiting example of edge signal generator 204 and so apparatus 300 may also be referred to as an “edge signal generator 300.”

Apparatus 300 includes a plurality of exclusive OR gates (XOR) denoted XOR 1 302, XOR 2 304, XOR 3 306, and XOR N 308. Apparatus 300 receives a plurality of samples of a bit, denoted, first sample 310, second sample 312, third sample 314, and Sample N 316; and outputs a plurality of component of edge signals for a sampled bit, denoted first bit 318, second bit 320, third bit 322, and edge signal N 324.

Samples 1 to N of a respective sampled bit of the RX signal 210 (e.g., provided by sampler 202, without limitation) are fed to respective first inputs of XOR gate 1 302 to XOR N 308 as depicted in FIG. 3, and adjacent samples fed to respective second inputs of the XOR gates as depicted in FIG. 3 so as to XOR function the samples. An XOR operation is sensitive to changes within a set of samples. If two adjacent samples are identical (both ‘0’ or both ‘1’), the XOR of these two samples will be a first value (e.g., a ‘0’, without limitation) indicating no change. If the two samples are different, the XOR of these two samples will be se second value (e.g., a ‘1’, without limitation) indicating a change or edge. Respective outputs of XOR 1 302, XOR 2 304, XOR 3 306 and XOR N 308 provide component edge signal 1 318 to edge signal N 324 (e.g., component signals of edge signal 214), respectively.

Sample 1 310 is XOR'd with sample N 316 of a previous set of samples that is delayed or held. The delay or hold is represented by block Z⁻¹ on the signal path of Sample N 316 to the second input of XOR 1 302 to indicate that the Sample N 316 received at that input is for a previous set of samples. Here, block Z⁻¹ indicates a sub-interval delay or hold so that the Nth sample may be compared to the 1st sample of the next sub-interval.

Notably, apparatus 300 can process sample 1 310 to sample N 316 in parallel-i.e., at substantially the same time, which is advantageous. Further, multiple instances of an apparatus 100 may process sets of samples in parallel, which is advantageous.

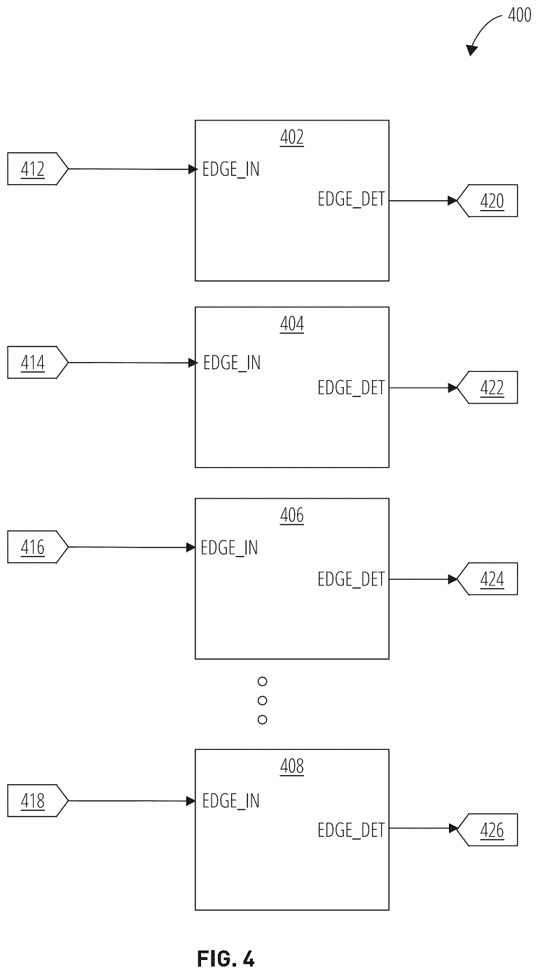

FIG. 4 is a block diagram depicting an apparatus 400 to generate a digital eye mask, in accordance with one or more examples. Apparatus 400 is a non-limiting example of edge detector 206 and so apparatus 400 may also be referred to as an “edge detector 400.”

Apparatus 400 includes edge detector 1 402, edge detector 2 404, edge detector 3 406 and edge detector N 408. Respective edge detectors 402 to 408 include an edge input (“EDGE_IN”) to receive a component edge signal, and an output (“EDGE_DET”) to provide an edge detection signal.

Component edge signals 1 412 to N 418 are fed to respective edge inputs of edge detector 1 402 to edge detector N 408 as depicted by FIG. 4. These component edge signals may be the component edge signals 1 318 to N 324 of FIG. 3.

Here, a “frame” is an n×m matrix of component edge signals where respective columns of the n×m matrix include the edge signals of respective sampled bits and respective rows of the n×m matrix represent respective sub-intervals of a bit interval. A frame (and an n×m matrix that forms such a frame) is effectively a digital eye diagram based on multiple bits of a received signal.

A respective edge detector 402 to 408 determines whether or not an edge is present in a respective sub-interval based on the respective component edge signal fed to the respective edge input EDGE_IN. In one or more examples, a respective edge detector 402 to 408 performs a multi-input logical OR operation on the set of respective component edge signals received between an assertion and a de-assertion of a frame start signal (frame start signal not depicted). A respective edge detector 402 to 408 sets its edge detection output EDGE_DET to a value that indicates the result of the logical OR operation. A first value (e.g., 0 or 1, without limitation) indicates no edge detected in the sub-interval, and a second, different value (e.g., 1 or 0, without limitation) indicates an edge detected in the sub-interval. In this manner, the edge detected signals 420 to 426 may be the values of a digital eye mask for an eye diagram corresponding to a frame of edge signals.

Notably, edge detector 1 402 to edge detector N 408 may operate and detect edges in parallel (at substantially the same time).

FIG. 5 is an example eye width determination based on the discussion above. Six sets of samples of are obtained from an eye diagram utilizing an 8× sampler including:
Set of samples 1: 00000001.
Set of samples 2: 11111111.
Set of samples 3: 00000000.
Set of samples 4: 11111111.
Set of samples 5: 10000000.
Set of samples 6: 01111111.

In this specific, non-limiting example, a set of samples corresponds to a respective bit, and the six sets of samples correspond to six bits. More or fewer than six bits and six sets of samples may be utilized without exceeding the scope of this disclosure. The value of a sample indicates whether or not the bit signal was determined to be high or a low at a respective sub-interval (here, a sub-interval corresponds to a sample interval), Using set of samples 1 as an example, the value of the sample in the 0th position is a ‘0’ and the value of the sample in the 1st position is a ‘0’ and so on and so forth until the value of the sample in the 7th position is a ‘1.’

Edge signals of a bit are determined by feeding a set of samples to edge signal generator 204 of FIG. 2 or apparatus 300 of FIG. 3 to generate component edge signals of an edge signal, as shown below (and FIG. 5):
Edge signal 1: 00000001.
Edge signal 2: 00000000.
Edge signal 3: 10000000.
Edge signal 4: 10000000.
Edge signal 5: 01000000.
Edge signal 6: 01000000.

Edge signal 1 corresponds to (i.e., is generated based on) set of samples 1, edge signal 2 corresponds to set of samples 2, and so on and so forth. Respective components of edge signals correspond to respective sub-intervals and thus the timing of an edge is stored in an edge signal 214. Since eye closures are made of edges and eye openings the absence of edges, a ‘1’ indicates an eye closure and a ‘0’ indicates an eye opening.

The edge signals 1 to 6 for the sets of samples are fed to edge detector 206 (or apparatus 400) as an n×m matrix (or “frame,” which corresponds to a digital eye diagram) for edge detection. Respective edge signals 1 to 6 are arranged in respective columns of the n×m matrix, with edge signal 1 in column 1, edge signal 2 in column 2, and so on and so forth, as shown below (and in FIG. 5):
0 0 1 1 0 0
1 1 0 0 0 0
0 0 0 0 0 0
0 0 0 0 0 0
0 0 0 0 0 0
0 0 0 0 0 0
0 0 0 0 0 0
0 0 0 0 0 1

Columns of the n×m matrix include the edge signals 1 to 6 and rows of the n×m matrix represent respective sub-intervals. Use of columns and rows in this example is simply for convenience and other arrangements do not exceed the scope of this disclosure, as a non-limiting example, rows of the n×m matrix may include the edge signals 1 to 6 and columns of the n×m matrix may represent sub intervals. The n×m matrix is effectively a digital eye diagram comprised of the edge signals 1 to 6.

A logical OR operation is performed by edge detector 206 (or apparatus 400) on the values in respective rows of the n×m matrix to determine whether or not an edge is present in any of the edge signals for a given sub-interval, and the results are stored in an array, which is the digital eye mask, as shown below (and in FIG. 5):
1
0
0
0
0
0
0

In this specific example of the digital eye mask, a 1 indicates an eye closure and a 0 indicates an eye opening. The 0's are counted to determine the eye width, which is 5 (e.g., the length of five sub-intervals). Other conventions may be utilized to represent eye openings and eye closures without exceeding the scope of this disclosure.

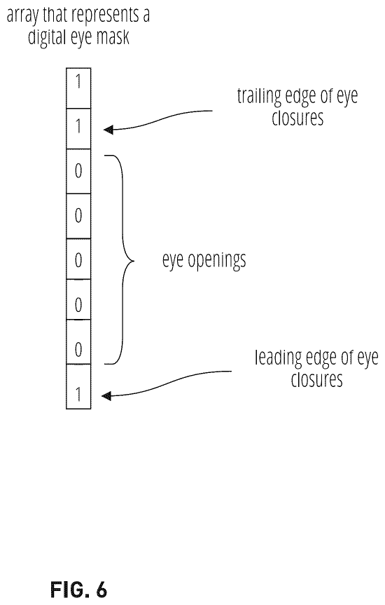

FIG. 6 is the digital eye mask array of FIG. 5 with labels identifying a first innermost edge of eye closures, eye openings, and a second innermost edge of eye closures-respectively indicated by the values of the digital eye mask array. In this example, time increases from bottom to top of the array (as it is depicted by FIG. 6), so the first innermost edge is a trailing edge because it occurs later in time than the second innermost edge, which is the leading edge. Other conventions could be used, such as time increasing from the top of the array to the bottom of the array, without exceeding the scope of this disclosure.

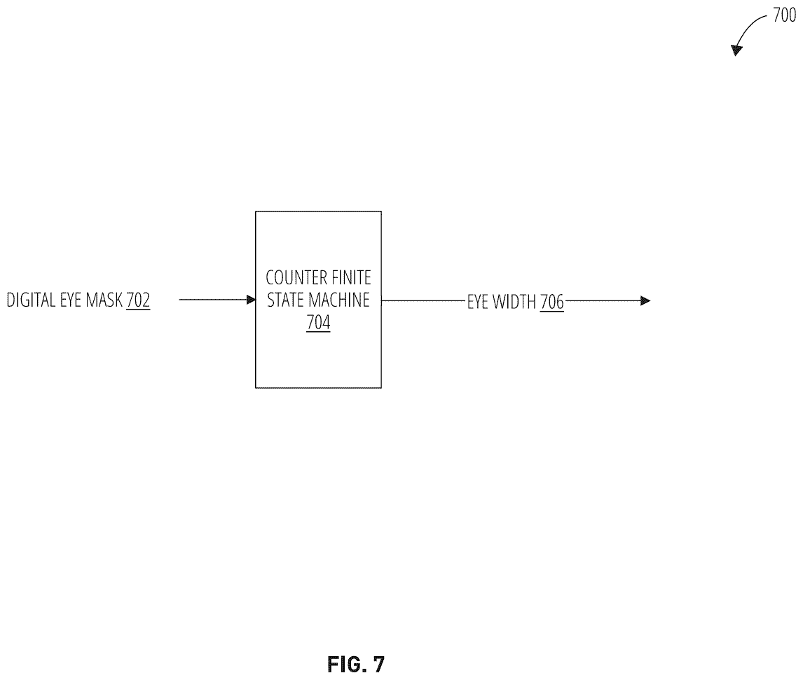

FIG. 7 is a block diagram of an apparatus 700 to determine an eye width based on a digital eye mask 702, in accordance with one or more examples. In one or more examples, apparatus 700 may form a portion of a signal quality analyzer 208 of FIG. 2.

Apparatus 700 includes counter finite state machine 704.

In one or more examples, counter finite state machine 704 counts occurrences of values that indicate eye openings between occurrences of values that indicate eye closures in digital eye mask 702 and provides the count as an eye width 706. Digital eye mask 702 includes values of edge detection signals received from edge detected signals 420 to 426 of apparatus 400 of FIG. 4.

Since respective values of the digital eye mask 702 correspond to respective consecutive, equal-duration, sub-intervals of a unit interval of an eye diagram. An eye width may be determined at least partially based on the number of eye openings between eye closures, for example, by counting the number of occurrences of consecutive eye openings between eye closures indicated in the digital eye mask.

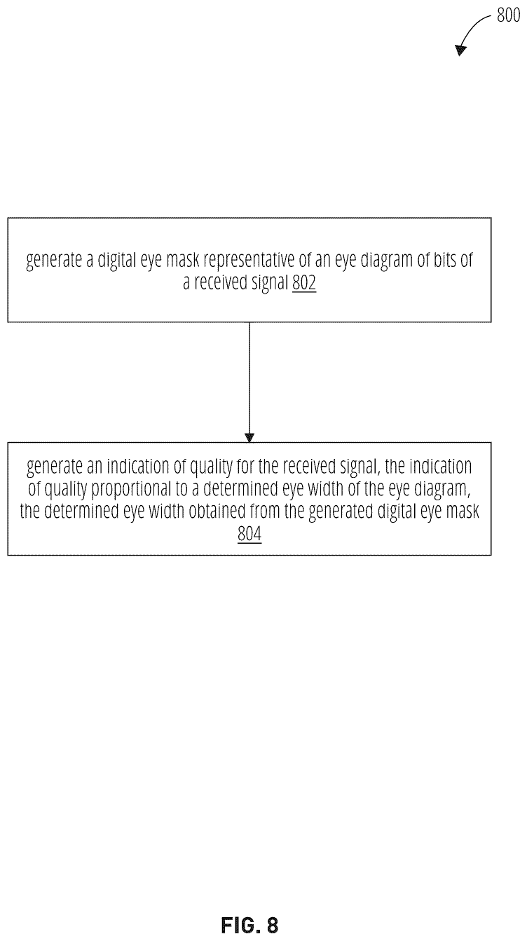

FIG. 8 illustrates an example process 800 to generate an indication of signal quality for a received signal in accordance with one or more examples. Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

According to one or more examples, process 800 may include generating a digital eye mask representative of an eye diagram of bits of a received signal, at operation 802. The bits of the received signal are encoded utilizing zero-crossings.

According to one or more examples, process 800 may include generating an indication of quality for the received signal, at operation 804. The indication of quality is proportional to a determined eye width of the eye diagram. The determined eye width is obtained from the generated digital eye mask.

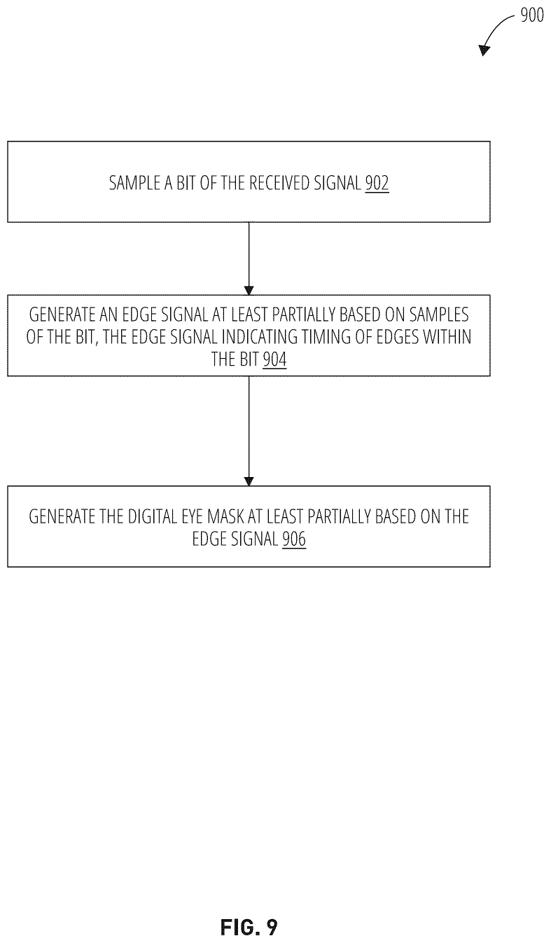

FIG. 9 illustrates an example process 900 to generate a digital eye mask in accordance with one or more examples. Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence.

According to one or more examples, process 900 may include sampling a bit of the received signal at operation 902. In some examples, respective samples may correspond to different, respective sub-intervals of a unit interval of an eye diagram.

According to one or more examples, process 900 may include generating an edge signal at least partially based on the samples of the bit, at operation 904. The edge signal indicates timing of edges within the bit.

According to one or more examples, process 900 may include generating the digital eye mask at least partially based on the edge signal at operation 906. As discussed above, in one or more examples, the digital eye mask may be generated by logical OR of component edge signals that correspond to like sub-intervals.

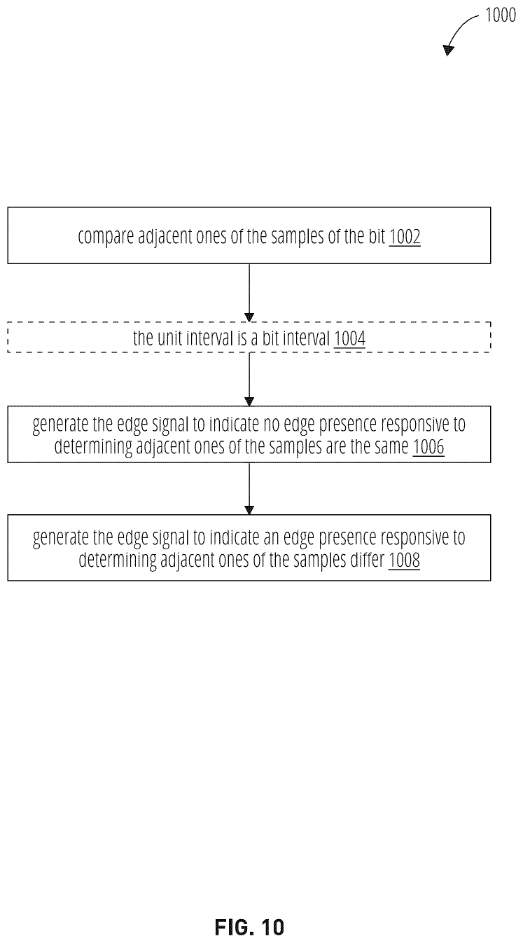

FIG. 10 illustrates an example process 1000 to generate an edge signal according to one or more examples. Although the example process 1000 depicts a particular sequence of operations, the sequence may be altered without departing from the scope of the present disclosure. For example, some of the operations depicted may be performed in parallel or in a different sequence that does not materially affect the function of the process 1000. In other examples, different components of an example device or system that implements the process 1000 may perform functions at substantially the same time or in a specific sequence.

According to one or more examples, process 1000 may include comparing adjacent ones of the samples of the bit at operation 1002. At operation 1004, a unit interval is a bit interval.

According to one or more examples, process 1000 may include generating the edge signal to indicate no edge presence responsive to determining adjacent ones of the samples are the same, at operation 1006.

According to one or more examples, process 1000 may include generating the edge signal to indicate an edge presence responsive to determining adjacent ones of the samples differ, at operation 1008.

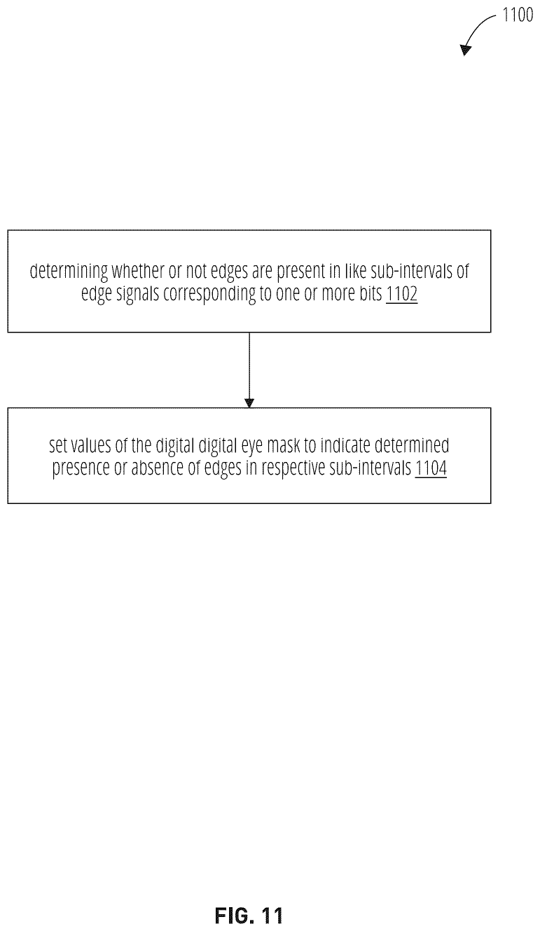

FIG. 11 illustrates an example process 1100 to determine values of a digital eye mask in accordance with one or more examples. Although the example process 1100 depicts a particular sequence of operations, the sequence may be altered without departing from the scope of the present disclosure. For example, some of the operations depicted may be performed in parallel or in a different sequence that does not materially affect the function of the process 1100. In other examples, different components of an example device or system that implements the process 1100 may perform functions at substantially the same time or in a specific sequence.

According to one or more examples, process 1100 may include determining whether or not edges are present in like sub-intervals of edge signals corresponding to one or more bits, at operation 1102.

According to one or more examples, process 1100 may include setting values of the digital eye mask to indicate presence or absence of edges in respective sub-intervals at least partially based on the determination at operation 1104.

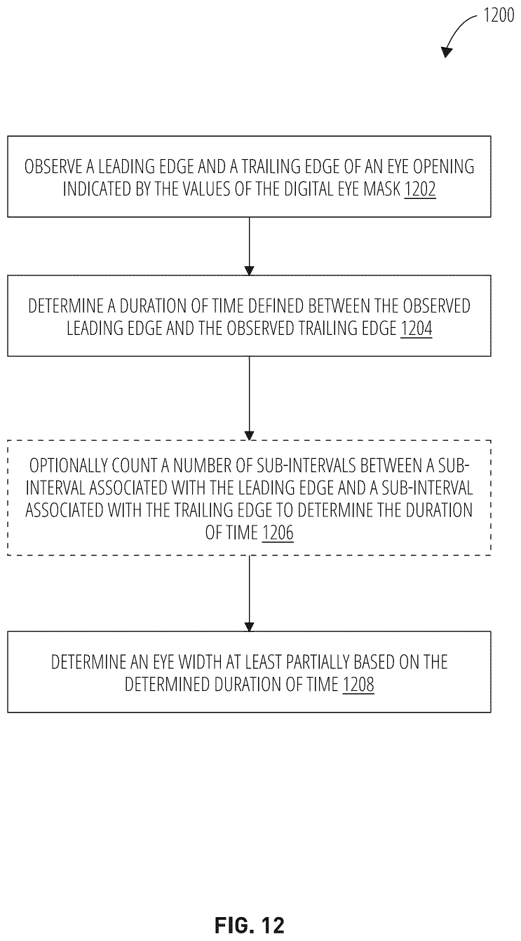

FIG. 12 illustrates an example process 1200 to determine an eye with based on a digital eye mask in accordance with one or more examples. Although the example process 1200 depicts a particular sequence of operations, the sequence may be altered without departing from the scope of the present disclosure. For example, some of the operations depicted may be performed in parallel or in a different sequence that does not materially affect the function of the process 1200. In other examples, different components of an example device or system that implements the process 1200 may perform functions at substantially the same time or in a specific sequence.

According to one or more examples, process 1200 may include observing a leading edge and a trailing edge of an eye opening indicated by the values of the digital eye mask at operation 1202.

According to one or more examples, process 1200 may include determining a duration of time defined between the observed leading edge and the observed trailing edge at operation 1204.

According to one or more examples, process 1200 may optionally include counting a number of sub-intervals between the sub-interval associated with the leading edge and the sub-interval associated with the trailing edge to determine the duration of time at operation 1206.

According to one or more examples, process 1200 may include determining an eye width at least partially based on the determined duration of time, at operation 1208.

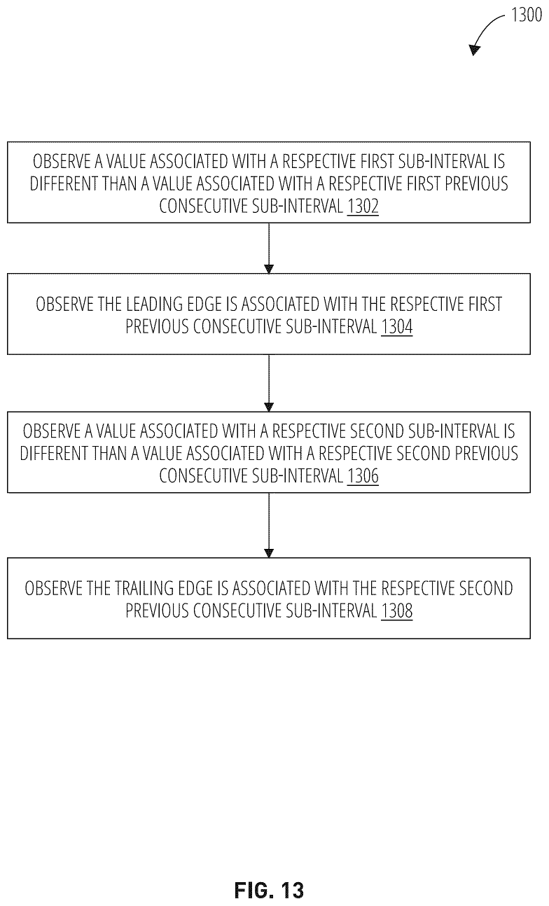

FIG. 13 illustrates an example process 1300 to determine leading and trailing edges of an eye diagram based on a digital eye mask in accordance with one or more examples. Although the example process 1300 depicts a particular sequence of operations, the sequence may be altered without departing from the scope of the present disclosure. For example, some of the operations depicted may be performed in parallel or in a different sequence that does not materially affect the function of the process 1300. In other examples, different components of an example device or system that implements the process 1300 may perform functions at substantially the same time or in a specific sequence.

According to one or more examples, process 1300 may include observing a value associated with a respective first sub-interval (e.g., a first value in a cell of the digital eye mask array, without limitation) is different than a value associated with a respective first previous consecutive sub-interval (e.g., a second value in an adjacent cell of the digital eye mask array, without limitation) at operation 1302.

According to one or more examples, process 1300 may include observing the leading edge is associated with the respective first previous consecutive sub-interval (e.g., the adjacent cell of the digital eye mask array, without limitations) at operation 1304.

According to one or more examples, process 1300 may include observing a value associated with a respective second sub-interval (e.g., a first further value in a further cell of the digital eye mask array, without limitation) is different than a value associated with a respective second previous consecutive sub-interval (e.g., a second further value in an adjacent further cell of the digital eye mask array, without limitation) at operation 1306.

According to one or more examples, process 1300 may include observing the trailing edge is associated with the respective second previous consecutive sub-interval (e.g., the adjacent further cell of the digital eye mask array, without limitation) at operation 1308.

In this manner, the locations (e.g., cells in the case of an array, without limitation) within the digital eye mask array associated with innermost edges of the eye (the transitions from eye closure to eye opening and eye opening to eye closure) may be identified.

In some cases, multiple eye widths respectively determined from respective sets of bits may be utilized to determine an indication of signal quality. In one or more examples, the number of eye widths utilized may be a predetermined number (e.g., 10, 100, 1000, 5000, without limitation), and when the threshold number of eye widths have been determined then the indication of quality may be determined based thereon. In one or more examples, the predetermined number of eye widths used as the threshold may be determined statistically.

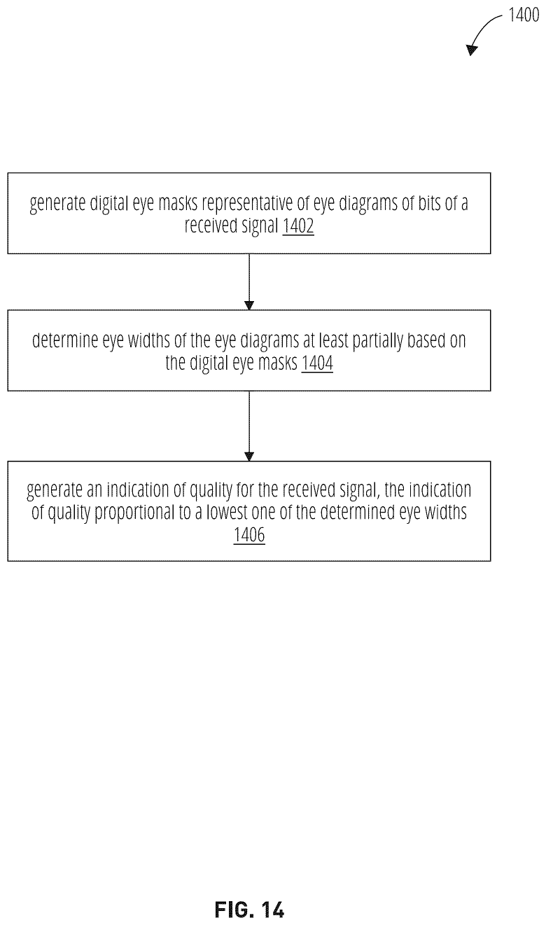

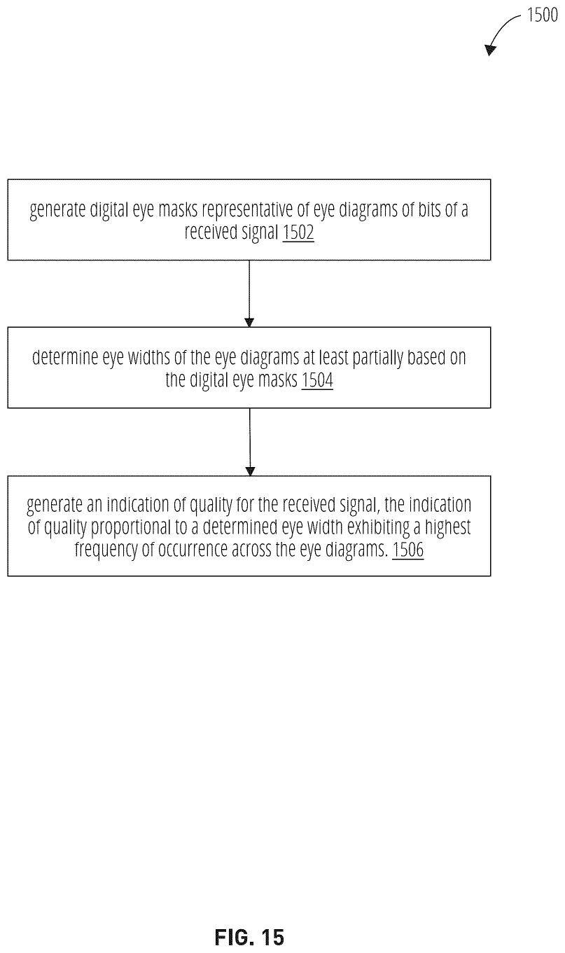

In FIG. 14 and FIG. 15 depict example processes to determine indications of quality based on multiple eye widths.

FIG. 14 illustrates an example process 1400 to determine an indication of signal quality, in accordance with one or more examples. Although the example process 1400 depicts a particular sequence of operations, the sequence may be altered without departing from the scope of the present disclosure. For example, some of the operations depicted may be performed in parallel or in a different sequence that does not materially affect the function of the process 1400. In other examples, different components of an example device or system that implements the process 1400 may perform functions at substantially the same time or in a specific sequence.

According to one or more examples, process 1400 may include generating digital eye masks representative of eye diagrams (e.g., of digital eye diagrams, without limitation) of bits of a received signal, at operation 1402. In one or more examples the bits may be encoded in a bit stream (e.g., using DME or another scheme, without limitation).

According to one or more examples, process 1400 may include determining eye widths of the eye diagrams (e.g., of the digital eye diagrams, without limitation) at least partially based on the digital eye masks at operation 1404.

According to some examples, process 1400 may include generating an indication of quality for the received signal, the indication of quality proportional to a lowest one of the determined eye widths at operation 1406. Using the lowest (narrowest) width is a conservative approach. Alternatively, the average or median eye width may be used.

FIG. 15 illustrates an example process 1500 to determine an indication of signal quality, in accordance with one or more examples. Although the example process 1500 depicts a particular sequence of operations, the sequence may be altered without departing from the scope of the present disclosure. For example, some of the operations depicted may be performed in parallel or in a different sequence that does not materially affect the function of the process 1500. In other examples, different components of an example device or system that implements the process 1500 may perform functions at substantially the same time or in a specific sequence.

According to one or more examples, process 1500 may include generating digital eye masks representative of eye diagrams of bits of a received signal, at operation 1502.

According to one or more examples, process 1500 may include determining eye widths of the eye diagrams (e.g., of digital eye diagrams, without limitation) at least partially based on the digital eye masks at operation 1504. In one or more examples the bits may be encoded in a bit stream (e.g., using DME or another scheme, without limitation).

According to some examples, process 1500 may include generating an indication of quality for the received signal, the indication of quality proportional to a determined eye width exhibiting a highest frequency of occurrence across the eye diagrams (e.g., across the digital eye diagrams, without limitation) at operation 1506. In one or more examples, the determined eye width exhibiting the highest frequency of occurrence may be identified via statistical alliance such as mode analysis, mean and median analysis, histogram analysis, standard deviation and variance analysis, cluster analysis, or combinations thereof, without limitation.

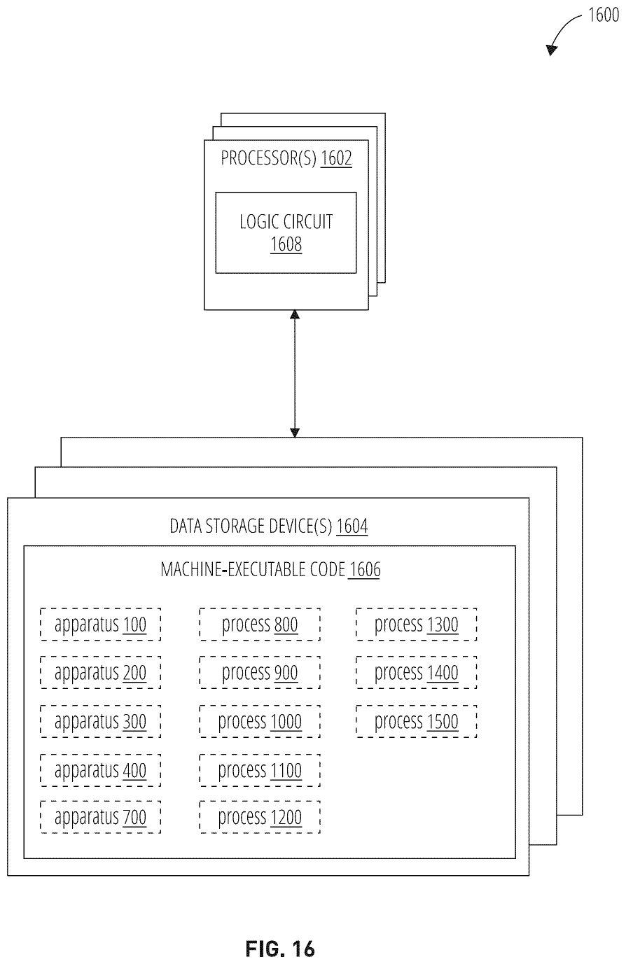

It will be appreciated by those of ordinary skill in the art that functional elements of examples disclosed herein (e.g., functions, operations, acts, processes, or methods) may be implemented in any suitable hardware, software, firmware, or combinations thereof. FIG. 16 illustrates non-limiting examples of implementations of functional elements disclosed herein. In some examples, some or all portions of the functional elements disclosed herein may be performed by hardware capable of carrying out the functional elements.

FIG. 16 is a block diagram of a circuitry 1600 that, in some examples, may be used to implement various functions, operations, acts, processes, or methods disclosed herein. The circuitry 1600 includes one or more processors 1602 (sometimes referred to herein as “processors 1602”) operably coupled to one or more data storage devices 1604 (sometimes referred to herein as “storage 1604”). The storage 1604 includes machine executable code 1606 stored thereon and the processors 1602 include logic circuit 1608. The machine executable code 1606 information describing functional elements that may be implemented by (e.g., performed by) the logic circuit 1608. The logic circuit 1608 is adapted to implement (e.g., perform) the functional elements described by the machine executable code 1606. The circuitry 1600, when executing the functional elements described by the machine executable code 1606, should be considered as special purpose hardware for carrying out functional elements disclosed herein. In some examples the processors 1602 may perform the functional elements described by the machine executable code 1606 sequentially, concurrently (e.g., on one or more different hardware platforms), or in one or more parallel process streams.

When implemented by logic circuit 1608 of the processors 1602, the machine executable code 1606 adapts the processors 1602 to perform operations of examples disclosed herein. By way of non-limiting example, the machine executable code 1606 may adapt the processors 1602 to perform some or a totality of operations of one or more of: process 800, process 900, process 1000, process 1100, process 1200, process 1300, process 1400, or process 1500.

Also by way of non-limiting example, the machine executable code 1606 may adapt the processors 1602 to perform some or a totality of features, functions, or operations disclosed herein for one or more of: apparatus 100, apparatus 200, apparatus 300, apparatus 400, or apparatus 700. More specifically, features, functions, or operations disclosed herein for one or more of: eye diagram digitizer 102 or signal quality analyzer 104; sampler 202, edge signal generator 204, edge detector 206, or signal quality analyzer 208; XOR 1 302, XOR 2 304, XOR 3 306, or XOR N 308; edge detector 1 402, edge detector 2 404, edge detector 3 406, or edge detector N 408; or counter finite state machine 704.

The processors 1602 may include a general purpose processor, a special purpose processor, a central processing unit (CPU), a microcontroller, a programmable logic controller (PLC), a digital signal processor (DSP), an application-specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine executable code 1606 (e.g., software code, firmware code, hardware descriptions) related to examples of the present disclosure. It is noted that a general-purpose processor (may also be referred to herein as a host processor or simply a host) may be a microprocessor, but in the alternative, the processors 1602 may include any conventional processor, controller, microcontroller, or state machine. The processors 1602 may also be implemented as a combination of computing devices, such as a combination of a DSP and a microprocessor, a plurality of microprocessors, one or more microprocessors in conjunction with a DSP core, or any other such configuration.

In some examples the storage 1604 includes volatile data storage (e.g., random-access memory (RAM)), non-volatile data storage (e.g., Flash memory, a hard disc drive, a solid state drive, erasable programmable read-only memory (EPROM), without limitation). In some examples the processors 1602 and the storage 1604 may be implemented into a single device (e.g., a semiconductor device product, a system on chip (SOC), without limitation). In some examples the processors 1602 and the storage 1604 may be implemented into separate devices.

In some examples the machine executable code 1606 may include computer-readable instructions (e.g., software code, firmware code). By way of non-limiting example, the computer-readable instructions may be stored by the storage 1604, accessed directly by the processors 1602, and executed by the processors 1602 using at least the logic circuit 1608. Also by way of non-limiting example, the computer-readable instructions may be stored on the storage 1604, transferred to a memory device (not shown) for execution, and executed by the processors 1602 using at least the logic circuit 1608. Accordingly, in some examples the logic circuit 1608 includes electrically configurable logic circuit 1608.

In some examples the machine executable code 1606 may describe hardware (e.g., circuitry) to be implemented in the logic circuit 1608 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1608 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine executable code 1606 may include an HDL, an RTL, a GL description, a mask level description, other hardware description, or any combination thereof.

In examples where the machine executable code 1606 includes a hardware description (at any level of abstraction), a system (not shown, but including the storage 1604) implements the hardware description described by the machine executable code 1606. By way of non-limiting example, the processors 1602 may include a programmable logic device (e.g., an FPGA or a PLC) and the logic circuit 1608 may be electrically controlled to implement circuitry corresponding to the hardware description into the logic circuit 1608. Also by way of non-limiting example, the logic circuit 1608 may include hard-wired logic manufactured by a manufacturing system (not shown, but including the storage 1604) according to the hardware description of the machine executable code 1606.

Regardless of whether the machine executable code 1606 includes computer-readable instructions or a hardware description, the logic circuit 1608 is adapted to perform the functional elements described by the machine executable code 1606 when implementing the functional elements of the machine executable code 1606. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Embodiment 1: A method, comprising: generating a digital eye mask representative of a digital eye diagram of bits of a received signal; and generating an indication of quality for the received signal, the indication of quality proportional to a determined eye width of the digital eye diagram, the determined eye width obtained from the generated digital eye mask.

Embodiment 2: The method according to Embodiment 1, comprising: sampling a unit interval of the received signal; generating an edge signal at least partially based on samples of the unit interval, the edge signal indicating timing of edges within the unit interval; and generating the digital eye mask at least partially based on the edge signal.

Embodiment 3: The method according to any of Embodiments 1 and 2, wherein the generating the edge signal comprises: comparing adjacent ones of the samples of the unit interval; and generating the edge signal to indicate no edge presence responsive to determining adjacent ones of the samples are the same; or to indicate an edge presence responsive to determining adjacent ones of the samples differ.

Embodiment 4: The method according to any of Embodiments 1 through 3, wherein the generating the digital eye mask comprises: determining whether or not edges are present in same respective sub-intervals of edge signals; and determining the digital eye mask to indicate determined presence or absence of edges in respective sub-intervals.

Embodiment 5: The method according to any of Embodiments 1 through 4, comprising: observing a leading edge and a trailing edge of an eye opening indicated by values of the digital eye mask; determining a duration of time defined between the observed leading edge and the observed trailing edge; and setting a value of the determined eye width at least partially based on the determined duration of time.

Embodiment 6: The method according to any of Embodiments 1 through 5, wherein the observing the leading edge and the trailing edge of the eye opening indicated by the values of the digital eye mask comprises: observing a value associated with a respective first sub-interval is different than a value associated with a respective first previous consecutive sub-interval; observing the leading edge is associated with the respective first previous consecutive sub-interval; observing a value associated with a respective second sub-interval is different than a value associated with a respective second previous consecutive sub-interval; and observing the trailing edge is associated with the respective second previous consecutive sub-interval.

Embodiment 7: The method according to any of Embodiments 1 through 6, wherein the determining the duration of time defined by the observed leading edge and the observed trailing edge comprises: counting a number of sub-intervals between the sub-interval associated with the leading edge and the sub-interval associated with the trailing edge; and determining the duration of time at least partially based on the counted number of sub-intervals.

Embodiment 8: The method according to any of Embodiments 1 through 7, wherein a unit interval of the diagram is a bit interval.

Embodiment 9: The method according to any of Embodiments 1 through 8, comprising: triggering an interrupt at least partially responsive to the indication of quality for the received signal being below a predetermined threshold.

Embodiment 10: The method according to any of Embodiments 1 through 9, wherein the received signal corresponds to an Ethernet frame.

Embodiment 11: An apparatus, comprising: an eye diagram digitizer to generate a digital eye mask representative of a digital eye diagram of bits of a received signal; and a signal quality analyzer to generate an indication of quality for the received signal, the indication of quality proportional to a determined eye width of the digital eye diagram, the determined eye width obtained from the generated digital eye mask.

Embodiment 12: The apparatus according to Embodiment 11, wherein the eye diagram digitizer comprises: a sampler to sample a bit of the received signal; an edge signal generator to generate an edge signal at least partially based on samples of the bit, the edge signal to indicate timing of edges within the bit; and an edge detector to generate values of the digital eye mask at least partially based on the edge signal.

Embodiment 13: The apparatus according to any of Embodiments 11 and 12, wherein the edge signal generator to: compare adjacent ones of the samples of the bit; and generate the edge signal comprising one or more of: indications of no edge presence responsive to determining adjacent ones of the samples are the same; or indications of edge presence responsive to determining adjacent ones of the samples differ.

Embodiment 14: The apparatus according to any of Embodiments 11 through 13, wherein the edge detector to: determine whether or not an edge is present in respective sub-intervals at least partially based on component edge signals corresponding to like sub-intervals; and set values of the digital eye mask to indicate determined presence or absence of edges in respective sub-intervals.

Embodiment 15: The apparatus according to any of Embodiments 11 through 14, wherein the signal quality analyzer to: observe a leading edge and a trailing edge of an eye opening indicated by the set values of the digital eye mask; determine a duration of time defined between the observed leading edge and the observed trailing edge; and set a value of the determined eye width at least partially based on the determined duration of time.

Embodiment 16: The apparatus according to any of Embodiments 11 through 15, wherein a measurement circuit to: observe a value associated with a respective first sub-interval is different than a value associated with a respective first previous consecutive sub-interval; observe the leading edge is associated with the respective first previous consecutive sub-interval; observe a value associated with a respective second sub-interval is different than a value associated with a respective second previous consecutive sub-interval; and observe the trailing edge is associated with the respective second previous consecutive sub-interval.

Embodiment 17: The apparatus according to any of Embodiments 11 through 16, wherein, to determine the duration of time defined by the observed leading and trailing edges, a measurement circuit to: count a number of sub-intervals between the sub-interval associated with the leading edge and the sub-interval associated with the trailing edge; and determine the duration of time at least partially based on the counted number of sub-intervals.

Embodiment 18: The apparatus according to any of Embodiments 11 through 17, wherein the signal quality analyzer to: compare calculated eye widths provided by a measurement circuit; and determine a narrowest calculated eye width from the calculated eye widths at least partially based on the comparing.

Embodiment 19: The apparatus according to any of Embodiments 11 through 18, wherein the signal quality analyzer to: determine a respective eye width that exhibits a highest frequency of occurrence among eye widths provided by a measurement circuit; and utilize the respective eye width that exhibits the highest frequency of occurrence as the a determined eye width of the digital eye diagram.

Embodiment 20: The apparatus according to any of Embodiments 11 through 19, wherein a digital eye mask includes values respectively associated with consecutive, equal-duration sub-intervals of a unit interval of the digital eye diagram.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the present disclosure as hereinafter claimed along with their legal equivalents. In addition, features from one example may be combined with features of another example while still being encompassed within the scope of the present disclosure.

What is claimed is:

1. A method, comprising:
generating a digital eye mask representative of a digital eye diagram of bits of a received signal; and
generating an indication of quality for the received signal, the indication of quality proportional to a determined eye width of the digital eye diagram, the determined eye width obtained from the generated digital eye mask.

2. The method of claim 1, comprising:
sampling a unit interval of the received signal;
generating an edge signal at least partially based on samples of the unit interval, the edge signal indicating timing of edges within the unit interval; and
generating the digital eye mask at least partially based on the edge signal.

3. The method of claim 2, wherein the generating the edge signal comprises:
comparing adjacent ones of the samples of the unit interval; and
generating the edge signal to indicate no edge presence responsive to determining adjacent ones of the samples are the same; or to indicate an edge presence responsive to determining adjacent ones of the samples differ.

4. The method of claim 2, wherein the generating the digital eye mask comprises:
determining whether or not edges are present in same respective sub-intervals of edge signals; and
determining the digital eye mask to indicate determined presence or absence of edges in respective sub-intervals.

5. The method of claim 4, comprising:
observing a leading edge and a trailing edge of an eye opening indicated by values of the digital eye mask;
determining a duration of time defined between the observed leading edge and the observed trailing edge; and
setting a value of the determined eye width at least partially based on the determined duration of time.

6. The method of claim 5, wherein the observing the leading edge and the trailing edge of the eye opening indicated by the values of the digital eye mask comprises:
observing a value associated with a respective first sub-interval is different than a value associated with a respective first previous consecutive sub-interval;
observing the leading edge is associated with the respective first previous consecutive sub-interval;
observing a value associated with a respective second sub-interval is different than a value associated with a respective second previous consecutive sub-interval; and
observing the trailing edge is associated with the respective second previous consecutive sub-interval.

7. The method of claim 5, wherein the determining the duration of time defined by the observed leading edge and the observed trailing edge comprises:
counting a number of sub-intervals between the sub-interval associated with the leading edge and the sub-interval associated with the trailing edge; and
determining the duration of time at least partially based on the counted number of sub-intervals.

8. The method of claim 3, wherein a unit interval of the diagram is a bit interval.

9. The method of claim 1, comprising:
triggering an interrupt at least partially responsive to the indication of quality for the received signal being below a predetermined threshold.

10. The method of claim 1, wherein the received signal corresponds to an Ethernet frame.

11. An apparatus, comprising:
an eye diagram digitizer to generate a digital eye mask representative of a digital eye diagram of bits of a received signal; and
a signal quality analyzer to generate an indication of quality for the received signal, the indication of quality proportional to a determined eye width of the digital eye diagram, the determined eye width obtained from the generated digital eye mask.

12. The apparatus of claim 11, wherein the eye diagram digitizer comprises:
a sampler to sample a bit of the received signal;
an edge signal generator to generate an edge signal at least partially based on samples of the bit, the edge signal to indicate timing of edges within the bit; and
an edge detector to generate values of the digital eye mask at least partially based on the edge signal.

13. The apparatus of claim 12, wherein the edge signal generator to:
compare adjacent ones of the samples of the bit; and
generate the edge signal comprising one or more of:
indications of no edge presence responsive to determining adjacent ones of the samples are the same; or
indications of edge presence responsive to determining adjacent ones of the samples differ.

14. The apparatus of claim 12, wherein the edge detector to:
determine whether or not an edge is present in respective sub-intervals at least partially based on component edge signals corresponding to like sub-intervals; and
set values of the digital eye mask to indicate determined presence or absence of edges in respective sub-intervals.

15. The apparatus of claim 11, wherein the signal quality analyzer to:
observe a leading edge and a trailing edge of an eye opening indicated by the set values of the digital eye mask;
determine a duration of time defined between the observed leading edge and the observed trailing edge; and
set a value of the determined eye width at least partially based on the determined duration of time.

16. The apparatus of claim 15, wherein a measurement circuit to:
observe a value associated with a respective first sub-interval is different than a value associated with a respective first previous consecutive sub-interval;
observe the leading edge is associated with the respective first previous consecutive sub-interval;
observe a value associated with a respective second sub-interval is different than a value associated with a respective second previous consecutive sub-interval; and
observe the trailing edge is associated with the respective second previous consecutive sub-interval.

17. The apparatus of claim 15, wherein, to determine the duration of time defined by the observed leading and trailing edges, a measurement circuit to:
count a number of sub-intervals between the sub-interval associated with the leading edge and the sub-interval associated with the trailing edge; and
determine the duration of time at least partially based on the counted number of sub-intervals.

18. The apparatus of claim 11, wherein the signal quality analyzer to:
compare calculated eye widths provided by a measurement circuit; and
determine a narrowest calculated eye width from the calculated eye widths at least partially based on the comparing.

19. The apparatus of claim 11, wherein the signal quality analyzer to:
determine a respective eye width that exhibits a highest frequency of occurrence among eye widths provided by a measurement circuit; and
utilize the respective eye width that exhibits the highest frequency of occurrence as the a determined eye width of the digital eye diagram.

20. The apparatus of claim 11, wherein a digital eye mask includes values respectively associated with consecutive, equal-duration sub-intervals of a unit interval of the digital eye diagram.
